(19) United States
(12) Patent Application Publication
(10) Pub. No.: US 2014/0211775 A1
(43) Pub. Date: Jul. 31, 2014

(54) LARGER DELAY SPREAD SUPPORT FOR WIFI BANDS

(71) Applicant: QUALCOMM Incorporated, San Diego, CA (US)

(72) Inventors: Hemanth SAMPATH, San Diego, CA (US); Vincent Knowles JONES, IV, Redwood City, CA (US); Sameer VERMANI, San Diego, CA (US); Didier Johannes Richard VAN NEE, Tull en't Waal (NL); Gwendolyn Denise BARRIAC, Encinitas, CA (US); Bin TIAN, San Diego, CA (US)

(73) Assignee: QUALCOMM INCORPORATED, San Diego, CA (US)

(21) Appl. No.: 14/165,262

(22) Filed: Jan. 27, 2014

Related U.S. Application Data
(60) Provisional application No. 61/816,640, filed on Apr. 26, 2013.
(60) Provisional application No. 61/757,656, filed on Jan. 28, 2013.

(51) Int. Cl. H04W 28/06

(52) U.S. Cl. CPC H04W 28/065
USPC 370/338

(57) ABSTRACT

Aspects of the present disclosure provide techniques that may help address the effects of larger delay spreads in WiFi bands. Methods and apparatus are provided that perform wireless communications utilizing varying cyclic prefix lengths, varying repetition intervals, and varying symbol durations to ameliorate the effects of large delay spreads.

### CROSS-REFERENCE TO RELATED APPLICATIONS

The present application for patent claims priority to U.S. Provisional Application No. 61/757,656, filed Jan. 28, 2013, and U.S. Provisional Application No. 61/816,640, filed Apr. 26, 2013, which are assigned to the assignee of the present application and hereby expressly incorporated by reference herein in their entirety.

### FIELD

Certain aspects of the present disclosure generally relate to wireless communications and, more particularly, to using information in the preamble of a data packet to support larger delay spread in the 2.4 and 5 GHz WiFi bands.

### BACKGROUND

In order to address the issue of increasing bandwidth requirements demanded for wireless communications systems, different schemes are being developed to allow multiple user terminals to communicate with a single access point by sharing the channel resources while achieving high data throughputs. Multiple Input Multiple Output (MIMO) technology represents one such approach that has recently emerged as a popular technique for next generation communication systems. MIMO technology has been adopted in several emerging wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Certain aspects of the present disclosure provide a method for wireless communications. The method generally includes generating a packet having a preamble decodable by a first type of device having a first set of capabilities and a second type of device having a second set of capabilities and transmitting the packet, wherein at least one field of the preamble is transmitted in a manner that allows the second type of device to determine a cyclic prefix length used in transmitting the packet.

Certain aspects of the present disclosure provide a method for wireless communications. The method generally includes generating a packet having a preamble comprising a set of one or more signal (SIG) fields, a first set of one or more training fields located before the set of SIG fields, and a second set of one or more training fields located after the set of SIG fields, wherein at least one of the first or second set of training fields has a repetition interval greater than 800 ns and transmitting the packet.

Certain aspects of the present disclosure provide a method for wireless communications. The method generally includes receiving a packet having a preamble decodable by a first type of device having a first set of capabilities and a second type of device having a second set of capabilities and determining, based on a manner in which at least one field of the preamble is transmitted, a cyclic prefix length used in transmitting the packet.

Certain aspects of the present disclosure provide a method for wireless communications. The method generally includes receiving a packet having a preamble comprising a set of one or more signal (SIG) fields, a first set of one or more training fields located before the set of SIG fields, and a second set of one or more training fields located after the set of SIG fields, wherein at least one of the first or second set of training fields has a repetition interval greater than 800 ns and decoding the packet.

Certain aspects of the present disclosure provide a method for wireless communications. The method generally includes generating a packet having a preamble decodable by a first type of device having a first set of capabilities and a second type of device having a second set of capabilities and transmitting the packet, wherein at least a portion of the packet after the preamble is transmitted using an increased symbol duration relative to one or more fields of the preamble.

Certain aspects of the present disclosure provide a method for wireless communications. The method generally includes generating a packet having a preamble decodable by a first type of device having a first set of capabilities and a second type of device having a second set of capabilities and transmitting the packet, wherein the packet provides an indication, to the second type of device, that an uplink transmission should be transmitted using an increased symbol duration relative to symbol durations decodable by the first type of device.

Certain aspects of the present disclosure provide a method for wireless communications. The method generally includes receiving a packet having a preamble decodable by a first type of device having a first set of capabilities and a second type of device having a second set of capabilities processing at least a portion of the packet after the preamble transmitted using an increased symbol duration relative to one or more fields of the preamble.

Certain aspects of the present disclosure provide a method for wireless communications. The method generally includes receiving a packet having a preamble decodable by a first type of device having a first set of capabilities and a second type of device having a second set of capabilities and processing the packet and detect an indication that an uplink transmission should be transmitted using an increased symbol duration relative to symbol durations decodable by the first type of device.

Various aspects also provide various apparatuses, program products, and devices (e.g., access points and other types of wireless devices) capable of performing the operations of the methods described above.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of a wireless communications network in accordance with certain aspects of the present disclosure.

FIG. 2 illustrates a block diagram of an example access point and user terminals in accordance with certain aspects of the present disclosure.

FIG. 3 illustrates a block diagram of an example wireless device in accordance with certain aspects of the present disclosure.

FIG. 4 illustrates an example structure of a preamble transmitted from an access point in accordance with certain aspects of the present disclosure.

FIG. 5 illustrates example legacy preamble structures, in accordance with certain aspects of the present disclosure.

FIG. 6 illustrates an example preamble structure, in accordance with certain aspects of the present disclosure.

FIG. 7 illustrates an example preamble structure, in accordance with certain aspects of the present disclosure.

FIG. 8 illustrates example operations that may be performed by an access point (AP), in accordance with certain aspects of the present disclosure.

FIG. 8A illustrates example components capable of performing the operations shown in FIG. 8.

FIG. 9 illustrates example operations that may be performed by a station, in accordance with certain aspects of the present disclosure.

FIG. 9A illustrates example components capable of performing the operations shown in FIG. 9.

FIG. 10 illustrates example operations that may be performed by an access point (AP), in accordance with certain aspects of the present disclosure.

FIG. 10A illustrates example components capable of performing the operations shown in FIG. 10.

FIG. 11 illustrates example operations that may be performed by a station, in accordance with certain aspects of the present disclosure.

FIG. 11A illustrates example components capable of performing the operations shown in FIG. 11.

FIG. 12 illustrates example operations that may be performed by an access point (AP), in accordance with certain aspects of the present disclosure.

FIG. 12A illustrates example components capable of performing the operations shown in FIG. 12.

FIG. 13 illustrates example operations that may be performed by an access point (AP), in accordance with certain aspects of the present disclosure.

FIG. 13A illustrates example components capable of performing the operations shown in FIG. 13.

FIG. 14 illustrates example operations that may be performed by a station, in accordance with certain aspects of the present disclosure.

FIG. 14A illustrates example components capable of performing the operations shown in FIG. 14.

FIG. 15 illustrates example operations that may be performed by a station, in accordance with certain aspects of the present disclosure.

FIG. 15A illustrates example components capable of performing the operations shown in FIG. 15.

### DETAILED DESCRIPTION

Aspects of the present disclosure provide techniques that may help address the effects of larger delay spreads in WiFi bands.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

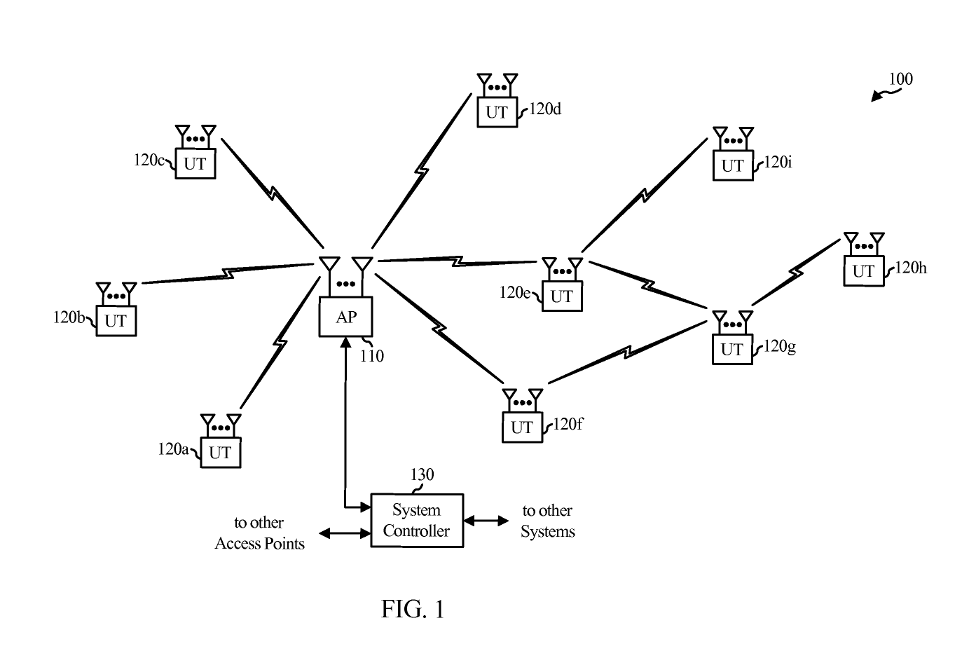

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

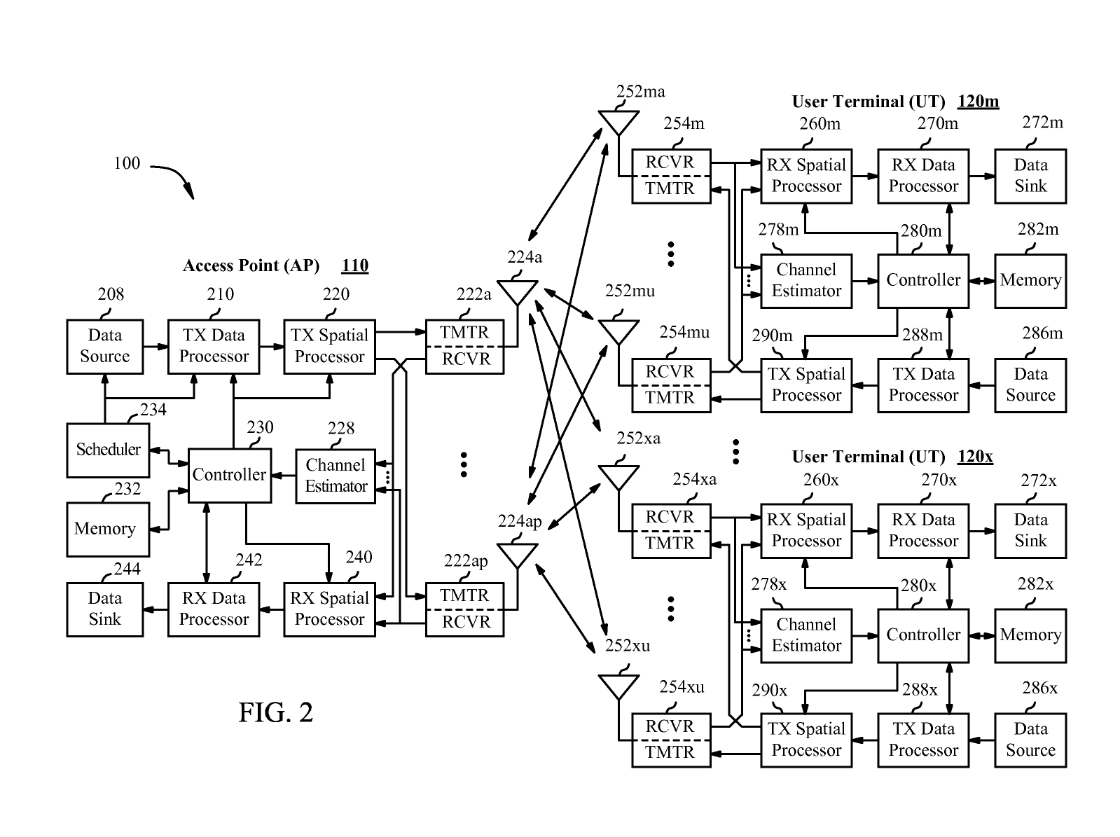

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 provide Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

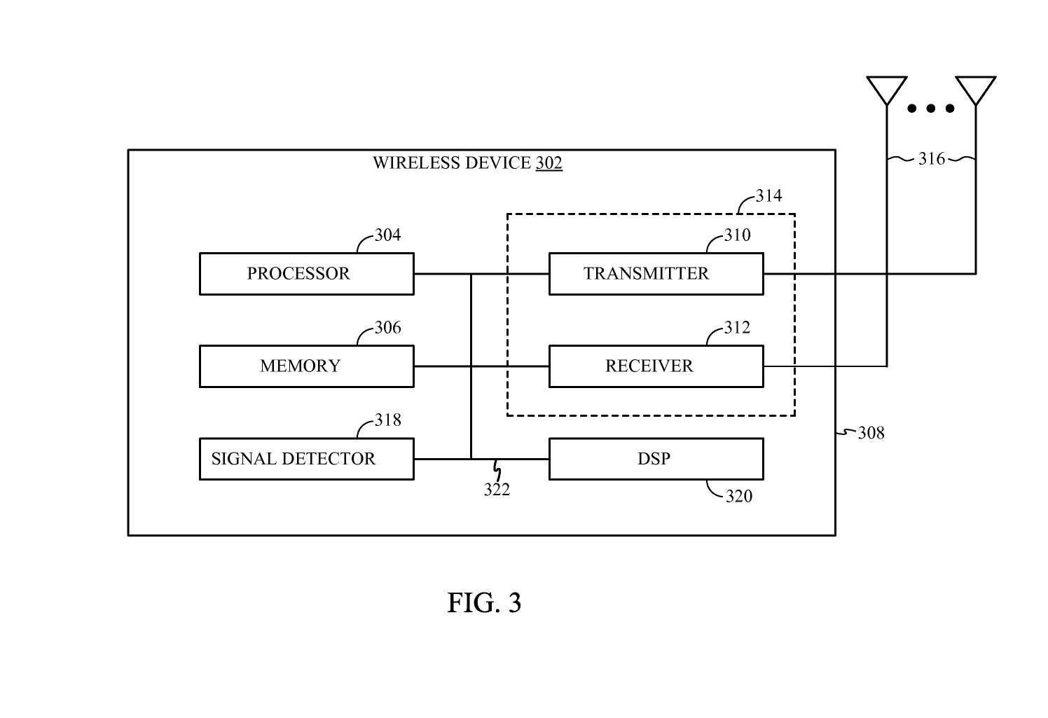

FIG. 3 illustrates various components that may be utilized in a wireless device 302 that may be employed within a wireless communication system (e.g., system 100 of FIG. 1). The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### An Example Preamble Structure

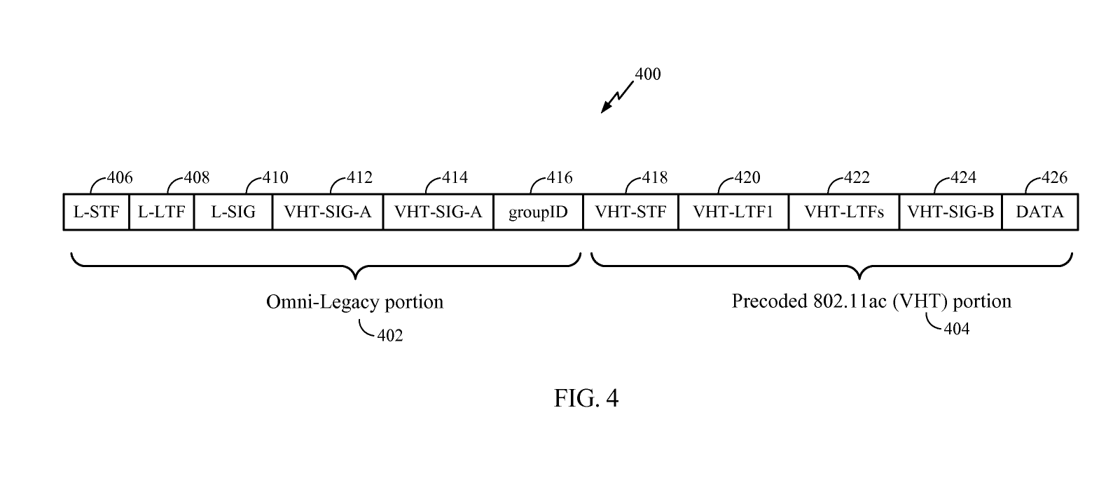

FIG. 4 illustrates an example structure of a preamble 400 in accordance with certain aspects of the present disclosure. The preamble 400 may be transmitted, for example, from the access point (AP) 110 to the user terminals 120 in a wireless network (e.g., system 100 illustrated in FIG. 1).

The preamble 400 may comprise an omni-legacy portion 402 (i.e., the non-beamformed portion) and a precoded 802.11ac VHT (Very High Throughput) portion 404. The legacy portion 402 may comprise: a Legacy Short Training Field (L-STF) 406, a Legacy Long Training Field (L-LTF) 408, a Legacy Signal (L-SIG) field 410, and two OFDM symbols 412, 414 for VHT Signal A (VHT-SIG-A) fields. The VHT-SIG-A fields 412, 414 may be transmitted omni-directionally and may indicate allocation of numbers of spatial streams to a combination (set) of STAs. For certain aspects, a group identifier (groupID) field 416 may be included in the preamble 400 to convey to all supported STAs that a particular set of STAs will be receiving spatial streams of a MU-MIMO transmission.

The precoded 802.11ac VHT portion 404 may comprise a Very High Throughput Short Training Field (VHT-STF) 418, a Very High Throughput Long Training Field 1 (VHT-LTF1) 420, Very High Throughput Long Training Fields (VHT-LTFs) 422, a Very High Throughput Signal B (VHT-SIG-B) field 424, and a data portion 426. The VHT-SIG-B field may comprise one OFDM symbol and may be transmitted precoded/beamformed.

Robust MU-MIMO reception may involve the AP transmitting all VHT-LTFs 422 to all supported STAs. The VHT-LTFs 422 may allow each STA to estimate a MIMO channel from all AP antennas to the STA's antennas. The STA may utilize the estimated channel to perform effective interference nulling from MU-MIMO streams corresponding to other STAs. To perform robust interference cancellation, each STA may be expected to know which spatial stream belongs to that STA, and which spatial streams belong to other users.

### Larger Delay Spread Support for WiFi Bands

Outdoor wireless networks with high access point (AP) elevation (e.g., on a Pico/Macro cell tower) may experience channels that have high delay spreads, well in excess of 1 μs. Various wireless systems, such as those in accordance with the Institute of Electrical and Electronics Engineers (IEEE) Standards 802.11a/g/n/ac, utilize orthogonal frequency division multiplexing (OFDM) physical layer (PHY) in the 2.4 and 5 GHz bands. The OFDM symbols have a Cyclic Prefix (CP) length of only 800 ns, nearly half of which is consumed by transmit and receive filters. Hence, these types of systems are typically considered unsuitable for such deployments, since WiFi packets with higher modulation and coding scheme (MCS) (e.g.: beyond MCS0) are difficult to decode in high delay spread channels.

According to aspects of the present disclosure, a packet format (PHY waveform) that is backwards compatible with such legacy systems and supports cyclic prefixes longer than 800 ns is provided that may allow the use of 2.4 and 5 GHz WiFi systems in outdoor deployments with high APs.

According to certain aspects of the present disclosure, one or more bits of information are embedded in one or more of a legacy short training field (L-STF), a legacy long training field (L-LTF), a legacy signal field (L-SIG), a very high throughput signal field (VHT-SIG), and a very high throughput short training field (VHT-STF) in the preamble of the PHY waveform. The one or more bits may be decoded by a new device, but do not impact decoding by legacy (e.g., 802.11a/g/n/ac) receivers.

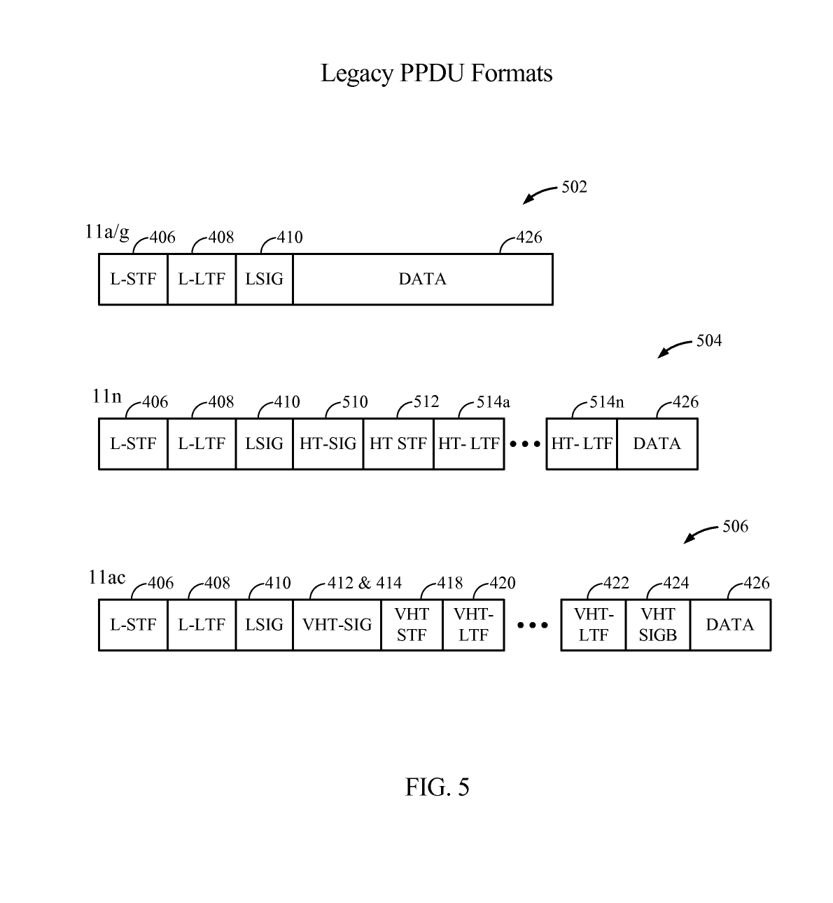

FIG. 5 illustrates example existing physical protocol data unit (PPDU) structures, for 802.11a/g, 802.11n, and 802.11ac. As shown in FIG. 5, the 11a/g physical protocol data unit (PPDU) format 502 may include a DATA field 426 and a preamble comprising L-STF 406, L-LTF 408, and L-SIG 410. The 11n PPDU format 504 may include all of the fields of the 11a/g PPDU, as well as additional preamble fields HT-SIG 510, HT-STF 512, and one or more HT-LTFs 514a . . . 514n. The 11ac PPDU format 506 may also include all of the fields of the 11a/g PPDU, as well as additional preamble fields VHT-SIG-A 412 and 414, VHT-STF 418, VHT-LTF1 420, one or more VHT-LTFs 422, and VHT-SIG-B 424.

L-SIG fields are binary phase shift keying (BPSK) modulated. HT-SIGs are quadrature-BPSK (Q-BPSK) modulated. The 2nd OFDM symbol of VHT-SIG is Q-BPSK modulated. The “Q” rotation of the HT-SIG and second OFDM symbol of the VHT-SIG may allow receivers to differentiate between 11a/g, 11n, and 11ac waveforms. 11a/g receivers that receive an 11n or 11ac packet may not be capable of decoding HT-SIG and VHT-SIG, but should defer transmitting and decoding for the duration of the packet, based on duration information that is included in the L-SIG field. 11n and 11ac receivers that receive an 11n format packet may determine that the packet is an 11n format packet by detecting the energy of the HT-SIG field and determining that the HT-SIG field includes symbols having “Q” rotation. 11n receivers that receive an 11ac format packet may not be capable of decoding the VHT-SIG, but should defer for the duration of the packet, based on the duration information included in the L-SIG field. 11ac receivers that receive an 11ac format packet may determine that the packet is an 11ac format packet by detecting the energy in each symbol of the VHT-SIG field and determining that the VHT-SIG field includes a first symbol that does not have “Q” rotation and a second symbol that does have “Q” rotation.

For certain aspects, one or more bits of information are embedded in one or more of L-STF, L-LTF, L-SIG, VHT-SIG, and VHT-STF that a new device can decode, but do not impact decoding by legacy 11a/g/n/ac receivers. The one or more bits of information are backwards compatible with the legacy preamble, i.e., 11a/g/n/ac devices are able to decode the preamble and then defer until the transmission is over.

According to certain aspects, the one or more bits can indicate to the new device techniques for decoding the succeeding symbols differently from 11a/g/n/ac techniques. The one or more bits can indicate to the new device that the OFDM numerology is different for the following symbols. As an example, for a 20 MHz waveform, a value of these bits (encoded in a manner in which one or more preamble fields are transmitted) may indicate one of the numerologies listed in the table below:

| | Fast Fourier | Cyclic Prefix | |
|---|---|---|---|
| Sampling Rate | Transform | (μs) | Carrier Spacing |
| same as 802.11 | 128 point | 1.6 | reduced |
| a/g/n/ac | | | |
| same as 802.11 | 256 point | 3.2 | reduced |
| a/g/n/ac | | | |
| same as 802.11 | 512 point | 6.4 | reduced |
| a/g/n/ac | | | |
| same as 802.11 | 64 point | 1.6 | same as 802.11 |
| a/g/n/ac | | | a/g/n/ac |
| same as 802.11 | 64 point | 3.2 | same as 802.11 |
| a/g/n/ac | | | a/g/n/ac |
| same as 802.11 | 64 point | 6.4 | same as 802.11 |
| a/g/n/ac | | | a/g/n/ac |
| reduced by 2x | 64 point | 1.6 | reduced |
| reduced by 4x | 64 point | 3.2 | reduced |
| reduced by 8x | 64 point | 6.4 | reduced |

For a 40 MHz waveform, the FFT sizes may be doubled relative to what is mentioned above, in order to multiplex the additional data that can be carried by the larger (40 MHz) channel. Similarly, for an 80 MHz waveform, the FFT sizes may quadruple relative to what is mentioned above.

According to certain aspects, a new sequence is added on the orthogonal dimension which is substantially lower power (e.g.: 10-20 dB attenuated) compared to the BPSK signal (i.e., the L-SIGs, HT-SIGs, and VHT-SIGs). Since the LSIG, HT-SIG and VHT-SIG symbols are either BPSK or Q-BPSK modulated in 11a/g/n/ac, the orthogonal dimension is unused and available for carrying the new sequence for all the tones.

The new sequence may be added in the frequency domain. The new sequence may be designed to maximize decoder performance. According to certain aspects, for a sequence that is 20 dB attenuated in L-SIG, legacy receiver L-SIG decode performance may degrade by less than 0.1 dB.

By designing the waveform to place the new sequence on the orthogonal dimension of L-SIG, symbols (V)HT-SIG and beyond may have the new numerology described above; and (V)HT-SIG bit-field mapping may be entirely different from the current 802.11a/g/n/ac standard.

For certain aspects, a new sequence may be modulated across L-SIG, HT-SIG, and VHT-SIG at a different power, for example, with 5 dB additional attenuation, which may result in negligible performance degradation to legacy receivers.

Designing the waveform to modulate the new sequence across L-SIG, HT-SIG, and VHT-SIG may require (V)HT-SIG to keep the same numerology and bitmap from the current 802.11a/g/n/ac standard.

According to certain aspects, new (advanced non-legacy) receivers may decode the new sequence by running a matched-filter correlator using the known sequence and channel after demodulation of L-SIG, HT-SIG, or VHT-SIG.

According to certain aspects, new receivers may decode the new sequence by first decoding L-SIG, HT-SIG, or VHT-SIG, then canceling the re-encoded and channel modulated L-SIG, HT-SIG, or VHT-SIG from the received signal, and finally running a matched-filter correlator using the known sequence and channel.

According to certain aspects, 2 reserved bits in VHT-SIG-A may be set to signal the new modes in an 802.11ac preamble. According to certain aspects, the new waveform may use the 2 reserved bits in VHT-SIG-A or some of the reserved modes to signal a new mode.

In 802.11ac, it is clear that a receiver must defer decoding L-SIG if VHT-SIG-A uses reserved bits. Using the 2 reserved bits in VHT-SIG-A requires that the average (rms) delay spread of the signal be small enough that VHT-SIG-A can be decoded.

According to certain aspects, reserved bits B2, B23 of VHTSIGA1 and B9 of VHTSIGA2 may be used to signal the new mode. According to certain aspects, any of the reserved bits may also be used to indicate a new bitmap of VHTSIGA1 and VHTSIGA2.

According to certain aspects, a new mode is signaled by changing the STF sequence of the waveform, such that new devices with direct correlation receivers can distinguish the new waveform, and legacy (e.g., 11n/a/ac/g) devices with delayed correlation can still detect the waveform.

Signaling a new mode by changing the STF sequence of the waveform may assume legacy devices use mostly delayed correlation. According to certain aspects, the new STF waveform may still have every 4th tone populated, and the peak-to-average power ratio (PAPR) may be comparable to the currently present STF waveform. According to certain aspects, the average (or rms) delay spread may need to be small enough that STF sensitivity is not affected.

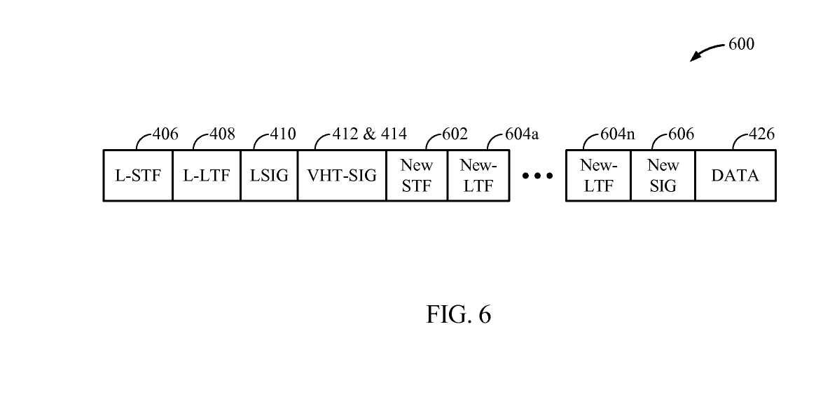

As illustrated in FIG. 6, according to certain aspects in which a root-mean-square (rms) delay spread is larger (e.g., more than 1 microsecond), L-SIG or VHT-SIG-A may not be able to be decoded, and sensitivity may be lost in L-STF detection. In these cases, a longer new STF 602 may be used after VHT-SIG-A that can be used for detection in large delay spreads. A new PPDU format 600 may also include new LTFs 604a . . . 604n and a new SIG 606 for transmission in implementations with large delay spreads. According to certain aspects, the new STF 602 may have a longer STF repetition interval (more than 800 ns) to handle gain adjustments for large delay spreads.

According to certain aspects, the new LTF, new SIG, and DATA may have a longer CP (>800 ns) and possibly different numerology for CP length and FFT size, as described above for 20/40/80 MHz signals, for example.

For certain aspects in which the root-mean-square (rms) delay spread is larger, e.g.: more than 1 microsecond, L-SIG or VHT-SIG-A cannot be decoded, and sensitivity is lost in L-STF detection. In these aspects, the legacy portions of the preamble may not be transmitted and only a new preamble may be transmitted.

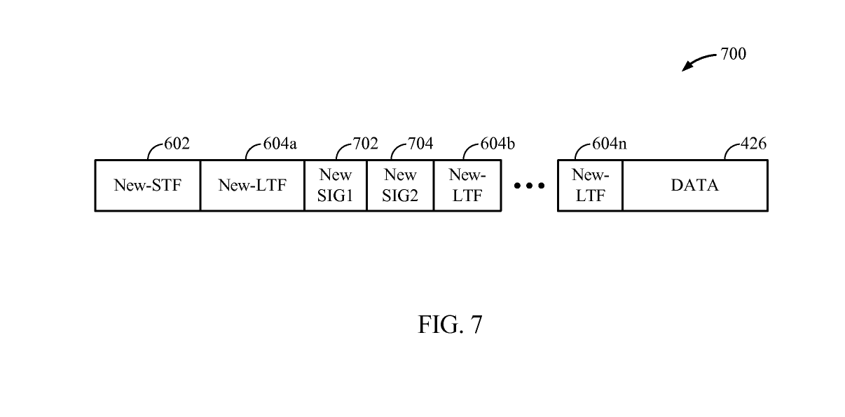

As illustrated in FIG. 7, according to certain aspects, the new STF may have a longer STF repetition interval (more than 800 ns) to handle gain adjustments for large delay spreads. A new PPDU format 700 may include the new STF 602, new LTFs 604a . . . 604n, a new SIG1 702, a new SIG2 704, and a DATA field 426. For certain aspects, the new LTFs, new SIG1, new SIG2, and DATA may have longer CP (more than 800 ns) and possibly different numerology for CP length and FFT size, as described above for 20/40/80 MHz signals, for example.

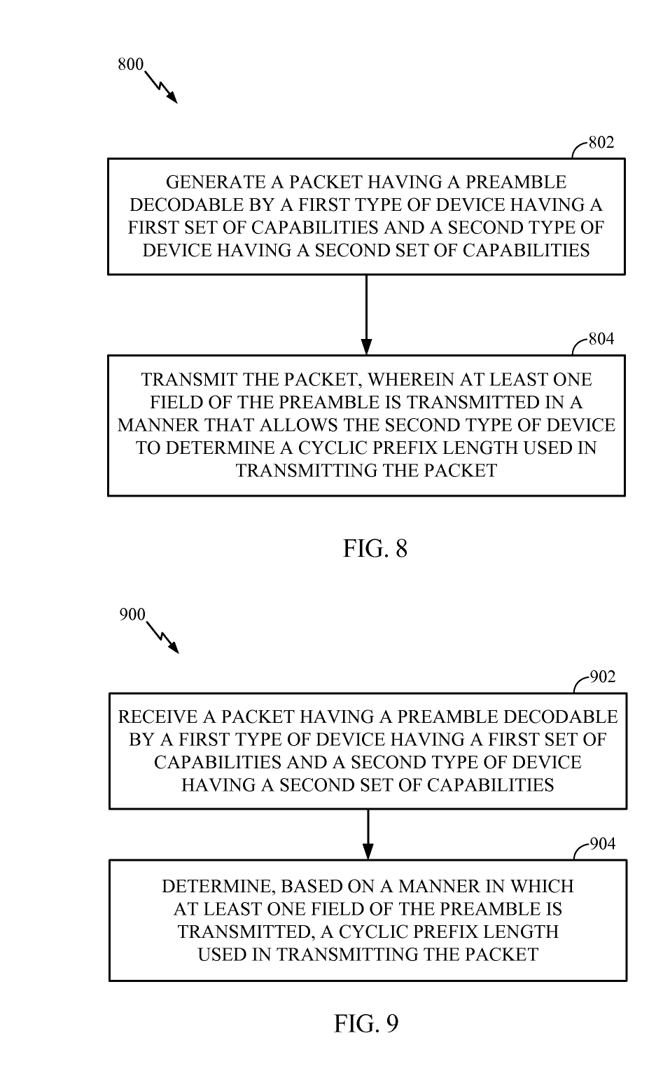

FIG. 8 illustrates example operations 800 that may be performed, for example, by an access point (AP) capable of generating a packet having a preamble decodable by a first type of device having a first set of capabilities and a second type of device having a second set of capabilities, in accordance with certain aspects of the present disclosure. As illustrated, at 802, the AP may generate a packet having a preamble decodable by a first type of device having a first set of capabilities and a second type of device having a second set of capabilities. At 804, the AP may transmit the packet, wherein at least one field of the preamble is transmitted in a manner that allows the second type of device to determine a cyclic prefix length used in transmitting the packet.

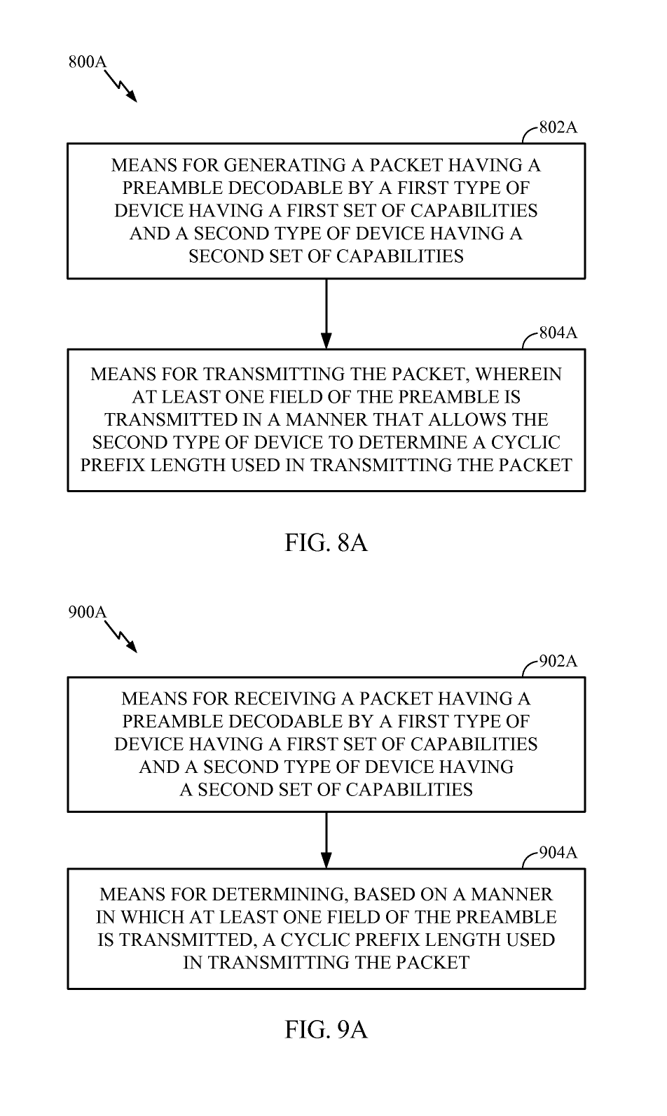

FIG. 9 illustrates example operations 900 that may be performed, for example, by a station capable of decoding a packet having a preamble decodable by a first type of device having a first set of capabilities and a second type of device having a second set of capabilities, wherein the station is the second type of device, in accordance with certain aspects of the present disclosure.

At 902, the station may receive a packet having a preamble decodable by a first type of device having a first set of capabilities and a second type of device having a second set of capabilities. At 904, the station determines, based on a manner in which at least one field of the preamble is transmitted, a cyclic prefix length used in transmitting the packet.

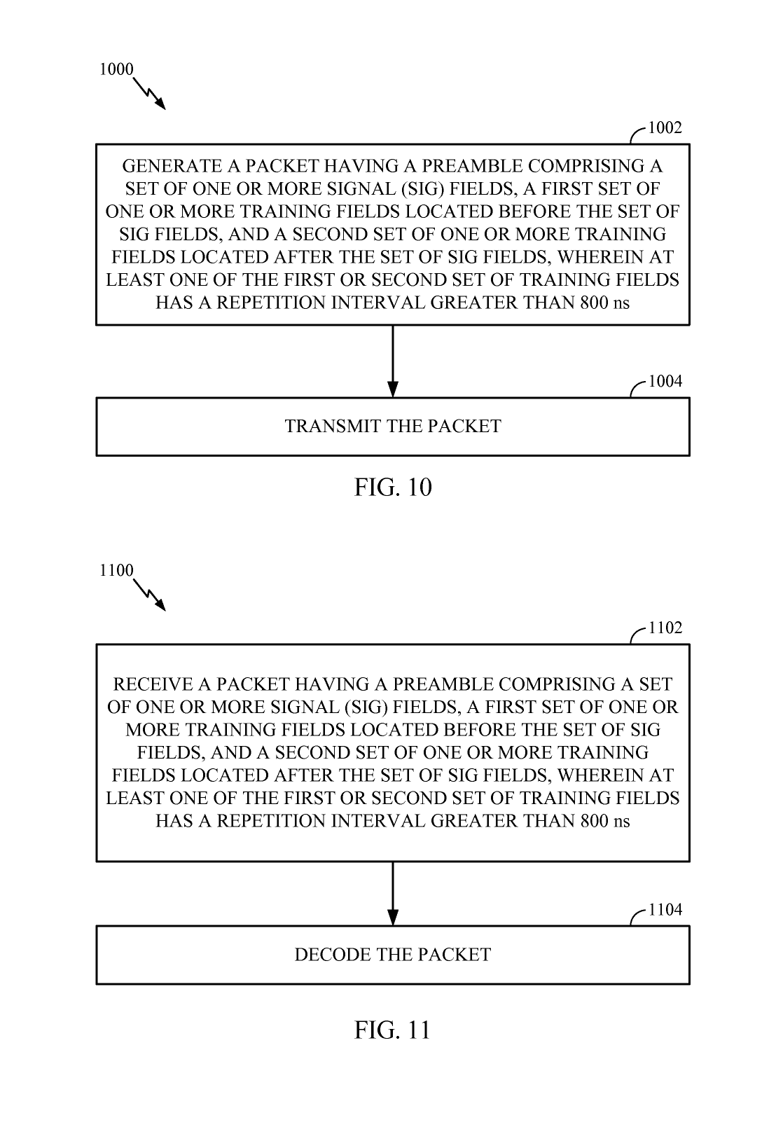

FIG. 10 illustrates example operations 1000 that may be performed, for example, by an access point (AP) capable of generating a packet having a preamble with a training field with a repetition interval greater than 800 ns, in accordance with certain aspects of the present disclosure.

At 1002, the AP may generate a packet having a preamble comprising a set of one or more signal (SIG) fields, a first set of one or more training fields located before the set of SIG fields, and a second set of one or more training fields located after the set of SIG fields, wherein at least one of the first or second set of training fields has a repetition interval greater than 800 ns. At 1004, the AP may transmit the packet.

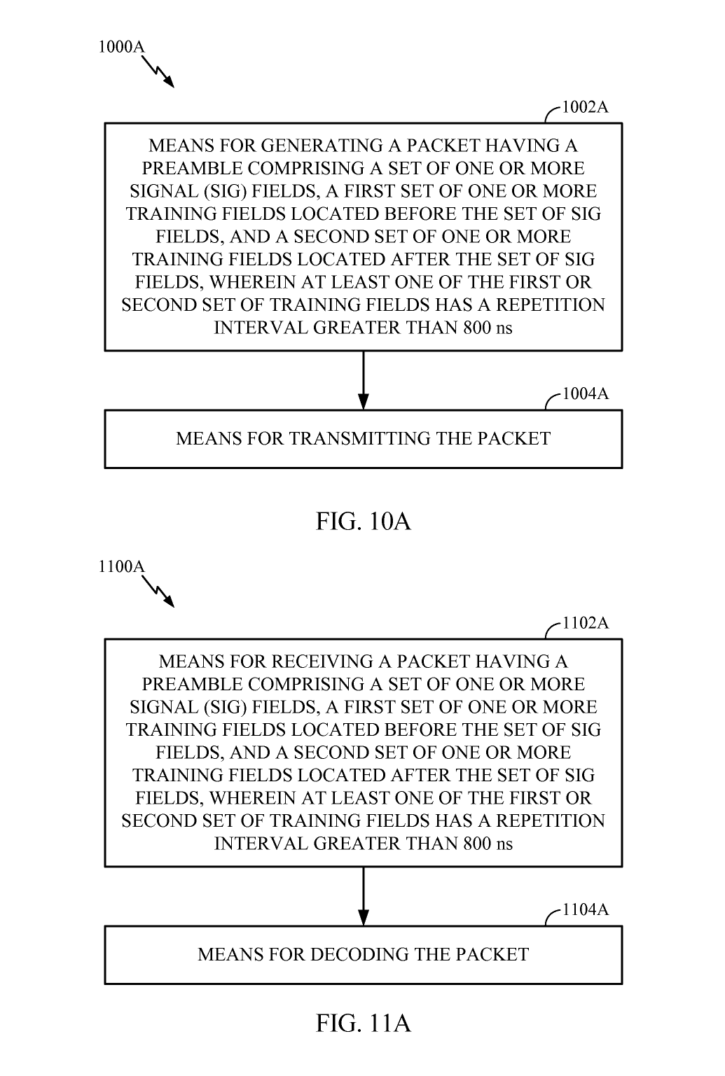

FIG. 11 illustrates example operations that may be performed, for example, by a station capable of decoding a packet having a preamble with a training field with a repetition interval greater than 800 ns, in accordance with certain aspects of the present disclosure.

At 1102, the station may receive a packet having a preamble comprising a set of one or more signal (SIG) fields, a first set of one or more training fields located before the set of SIG fields, and a second set of one or more training fields located after the set of SIG fields, wherein at least one of the first or second set of training fields has a repetition interval greater than 800 ns. At 1104, the station may decode the packet.

As discussed above, for delay spread tolerance, different transmission parameters may be used to increase symbol duration (e.g., downclocking to actually decrease sample rate or increasing FFT length while maintaining a same sample rate). The symbol duration may be increased, for example, 2× to 4×, to increase tolerance to higher delay spreads. The increase may be accomplished via down-clocking (using a lower sampling rate with a same FFT length) or by increasing a number of subcarriers (a same sampling rate, but increased FFT length).

Use of an increased symbol duration may be considered a physical layer (PHY) transmission mode that can be signaled in the SIG field, which may allow a normal symbol duration mode to be maintained. Preserving the “normal” symbol duration mode may be desirable (even for devices that are capable of using an increased symbol duration mode) because increased symbol duration typically means increased FFT size, which brings with it an increased sensitivity to frequency error and increased PAPR. Further, not every device in a network will need this increased delay spread tolerance and, in such cases, increased FFT size can actually hurt performance.

Depending on a particular implementation, such an OFDM symbol duration increase (e.g., through an increase in number of sub-carriers) may happen after the SIG field in all packets—or may be signaled for only some packets. The SIG field may be a high efficiency SIG (HE-SIG) field (as defined by IEEE 802.11 High Efficiency WLAN or HEW Study Group) or a VHT-SIG-A field (e.g., per 802.11ac).

If not applied to all packets, OFDM symbol duration increase (e.g., through an increase in number of sub-carriers) may happen after the SIG field only in packets where information in the SIG field signals the change. The information may be conveyed through a bit in the SIG field, through a Q-BPSK rotation of a SIG field symbol, or through hidden information in the orthogonal rail (imaginary axis) of any of the SIG fields.

Increased symbol duration may also be used for UL transmissions. For the UL transmissions, it is possible that the AP indicates through a DL message that it wants the next transmission to be with increased symbol duration. For example, in UL OFDMA, the AP may send a tone allocation message which along with distributing the tone allocation also tells the users to use longer symbol durations. In that case, the UL packet itself does not need to carry the indication about this numerology change. That is because the AP initiated this transmission in the first place and decided the symbol duration to be used by the STAs in the UL.

The indication of increased symbol duration in UL transmissions may be conveyed in the preamble (as described above) or may be conveyed via one or more bits in a data payload of the DL frame. Such payload will be understandable only by devices that support the increased symbol duration. In addition, the increased symbol duration in the UL may be applied to the whole UL packet, as well. As an alternative, the indication may also be conveyed separately from the DL frame. For example, use of increased symbol duration on the UL could be scheduled semi-persistently, where a STA is signaled whether (or not) to use increased symbol duration on UL transmissions. This approach may save an AP from having to signal in each DL frame.

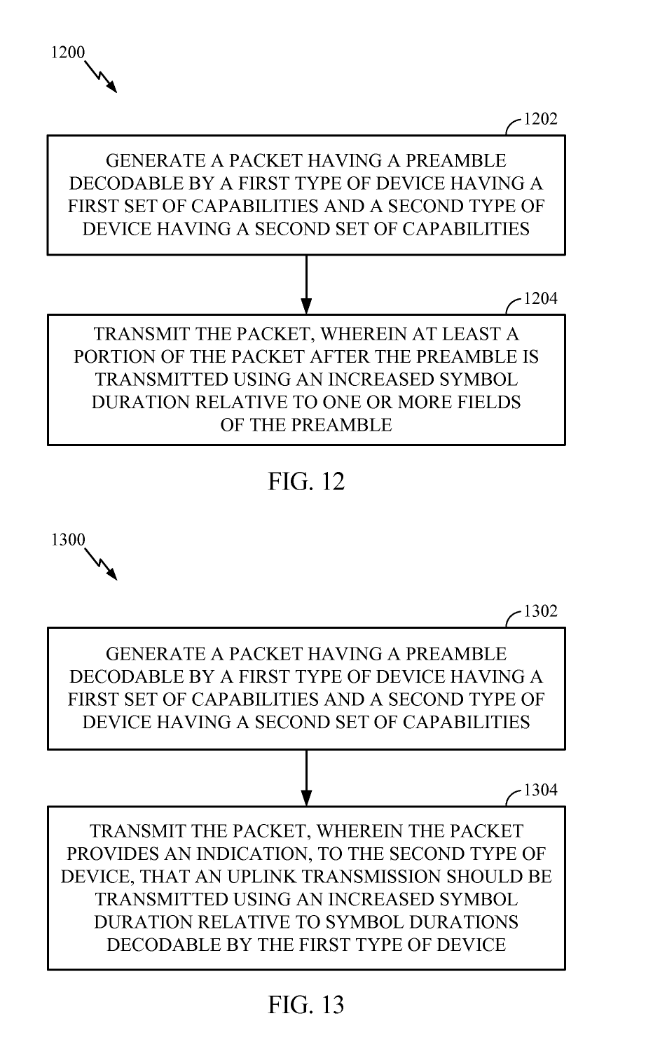

FIG. 12 illustrates example operations 1200 that may be performed by an access point (AP) capable of generating a packet with a portion with an increased symbol duration relative to one or more fields of the preamble of the packet to transmit at least a portion of a packet using an increased symbol duration, in accordance with certain aspects of the present disclosure.

At 1202, the AP may generate a packet having a preamble decodable by a first type of device having a first set of capabilities and a second type of device having a second set of capabilities. At 1204, the AP may transmit the packet, wherein at least a portion of the packet after the preamble is transmitted using an increased symbol duration relative to one or more fields of the preamble.

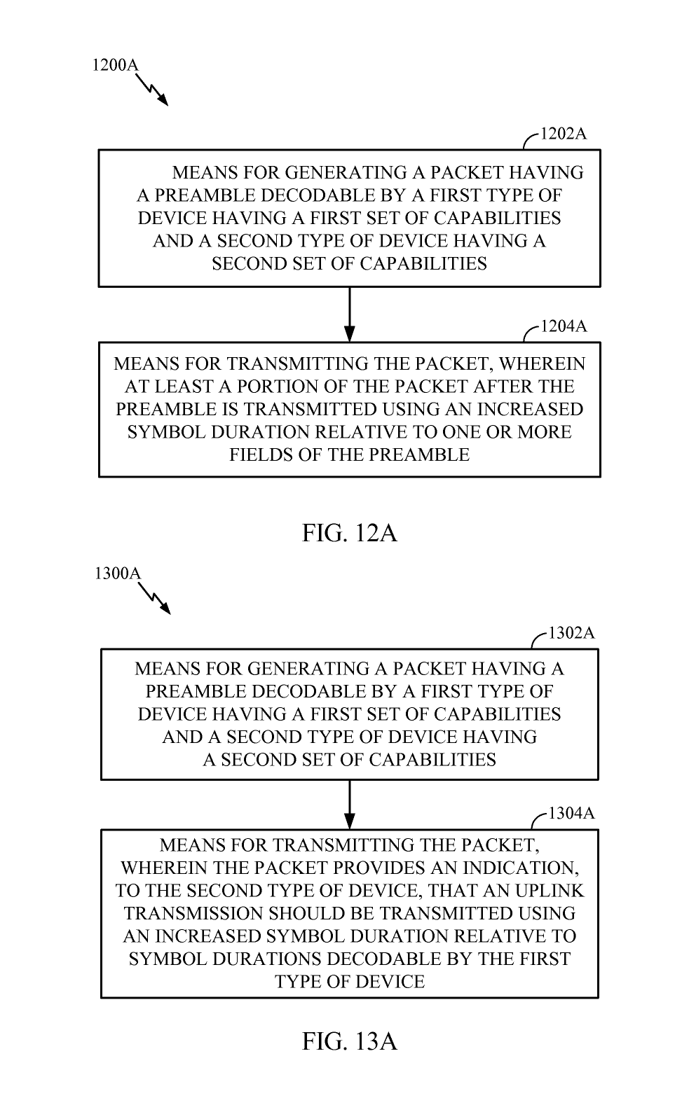

FIG. 13 illustrates example operations 1300 that may be performed by an access point (AP) capable of generating a packet having a preamble decodable by a first type of device having a first set of capabilities and a second type of device having a second set of capabilities to indicate that at least a portion of an uplink transmission is to be transmitted using an increase symbol duration, in accordance with certain aspects of the present disclosure.

At 1302, the AP may generate a packet having a preamble decodable by a first type of device having a first set of capabilities and a second type of device having a second set of capabilities. At 1304, the AP may transmit the packet, wherein the packet provides an indication, to the second type of device, that an uplink transmission should be transmitted using an increased symbol duration relative to symbol durations decodable by the first type of device.

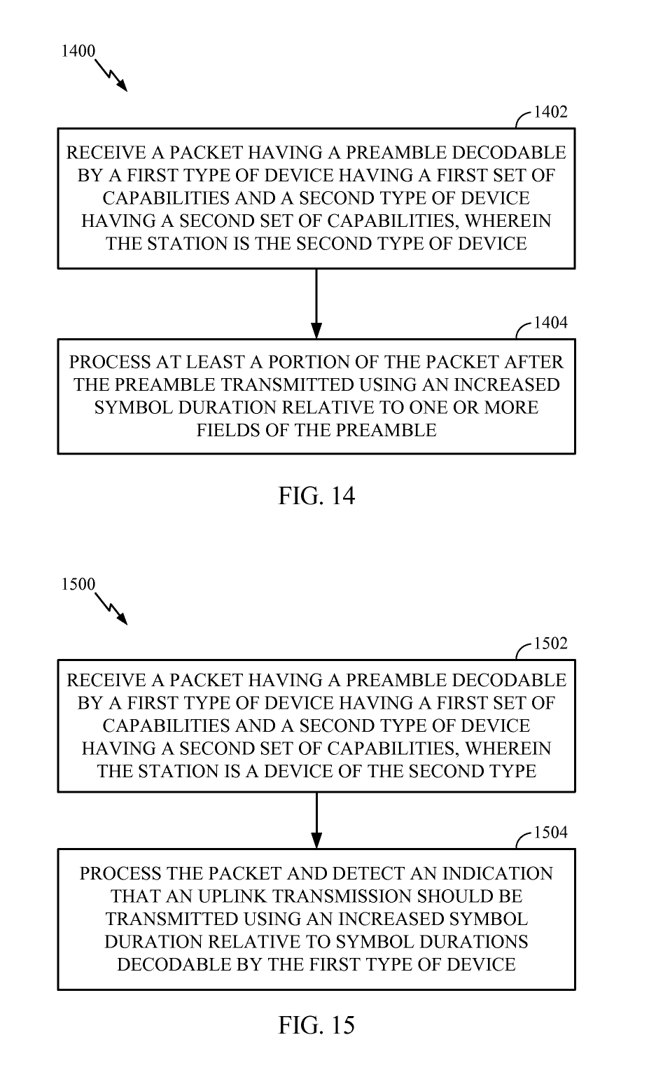

FIG. 14 illustrates example operations 1400 that may be performed by a station capable of decoding a packet having a preamble decodable by a first type of device having a first set of capabilities and a second type of device having a second set of capabilities, wherein the station is the second type of device, to process at least a portion of a packet transmitted using an increased symbol duration, in accordance with certain aspects of the present disclosure.

At 1402, the station may receive a packet having a preamble decodable by a first type of device having a first set of capabilities and a second type of device having a second set of capabilities, wherein the station is the second type of device. At 1404, the station may process at least a portion of the packet after the preamble transmitted using an increased symbol duration relative to one or more fields of the preamble.

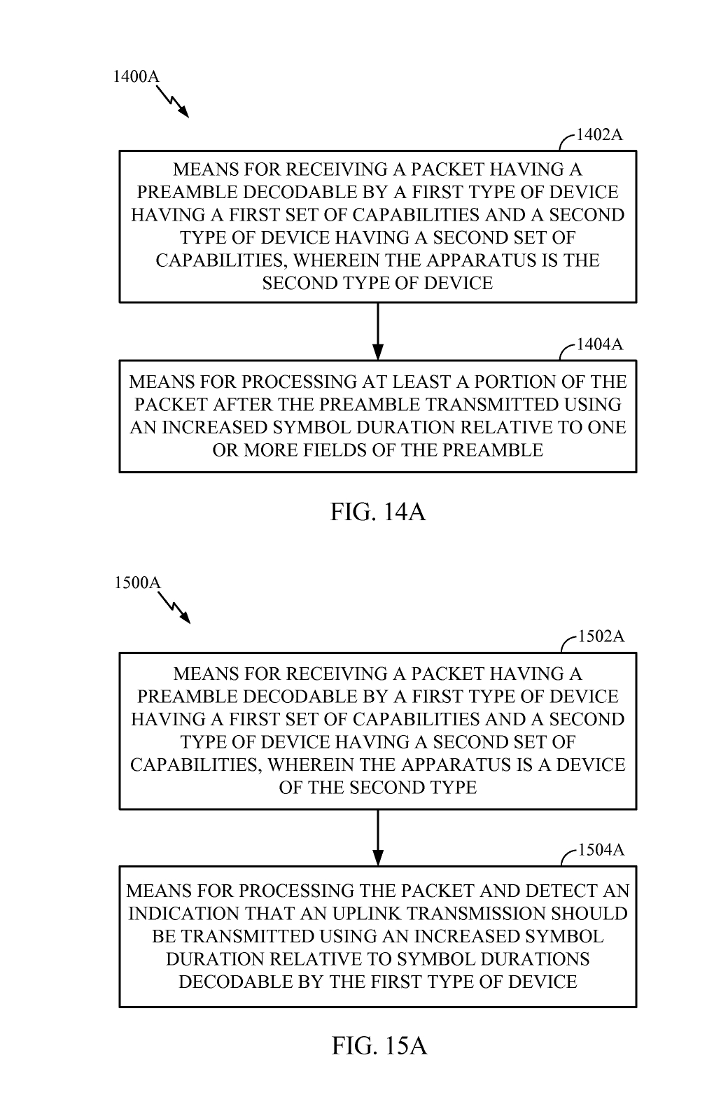

FIG. 15 illustrates example operations 1500 that may be performed by a station capable of decoding a packet having a preamble decodable by a first type of device having a first set of capabilities and a second type of device having a second set of capabilities, wherein the station is a device of the second type, to detect an indication that at least a portion of an uplink transmission is to be transmitted using an increase symbol duration, in accordance with certain aspects of the present disclosure.

At 1502, the station may receive a packet having a preamble decodable by a first type of device having a first set of capabilities and a second type of device having a second set of capabilities, wherein the station is a device of the second type. At 1504, the station may process the packet and detect an indication that an uplink transmission should be transmitted using an increased symbol duration relative to symbol durations decodable by the first type of device.

The various operations of methods described above may be performed by any suitable means capable of performing the corresponding functions. The means may include various hardware and/or software component(s) and/or module(s), including but not limited to a circuit, an application specific integrated circuit (ASIC), or processor. Generally, where there are operations illustrated in figures, those operations may have corresponding counterpart means-plus-function components with similar numbering. For example, operations 800, 900, 1000, 1100, 1200, 1300, 1400, and 1500 illustrated in FIGS. 8, 9, 10, 11, 12, 13, 14, and 15, may correspond to means 800A, 900A, 1000A, 1100A, 1200A, 1300A, 1400A, and 1500A illustrated in FIGS. 8A, 9A, 10A, 11A, 12A, 13A, 14A, and 15A.

For example, means for transmitting may comprise a transmitter, such as the transmitter unit 222 of the access point 110 illustrated in FIG. 2, the transmitter unit 254 of the user terminal 120 depicted in FIG. 2, or the transmitter 310 of the wireless device 302 shown in FIG. 3. Means for receiving may comprise a receiver, such as the receiver unit 222 of the access point 110 illustrated in FIG. 2, the receiver unit 254 of the user terminal 120 depicted in FIG. 2, or the receiver 312 of the wireless device 302 shown in FIG. 3. Means for processing, means for determining, means for altering, means for generating, means for correcting, and/or means for checking may comprise a processing system, which may include one or more processors, such as the RX data processor 270 and/or the controller 280 of the user terminal 120 or the RX data processor 242 and/or the controller 230 of the access point 110 illustrated in FIG. 2.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM, or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a processing system configured to generate a packet having a preamble decodable by a first type of device having a first set of capabilities and a second type of device having a second set of capabilities and transmit the packet, wherein at least one field of the preamble is transmitted in a manner that allows the second type of device to determine a cyclic prefix length used in transmitting the packet; and
a memory coupled with the processing system.

2. The apparatus of claim 1, wherein the at least one field of the preamble comprises at least one of a L-STF, L-LTF, L-SIG, VHT-SIG, or VHT-STF field.

3. The apparatus of claim 1, wherein the at least one field of the preamble is transmitted in a manner that allows the second type of device to determine, for a given channel bandwidth, a cyclic prefix length and a FFT size.

4. The apparatus of claim 1, wherein:
the at least one field of the preamble is transmitted using at least one of BPSK or Q-BPSK modulation; and
the processing system is configured to transmit a sequence, in an orthogonal dimension to the BPSK or Q-BPSK transmission, that identifies the cyclic prefix length and a FFT size used in transmitting the packet.

5. The apparatus of claim 4, wherein the sequence is transmitted at a lower power than the BPSK or Q-BPSK transmission.

6. The apparatus of claim 1, wherein:
the first type of device is compatible with a first version of a standard in which one or more bits in the at least one field of the preamble are reserved; and
one or more of the reserved bits are used to determine a cyclic prefix length used in transmitting the packet.

7. The apparatus of claim 1, wherein the at least one field of the preamble comprises a VHT-SIG field.

8. The apparatus of claim 1, wherein:
the at least one field of the preamble comprises a STF field; and
the STF field comprises a STF sequence that devices of the second type can distinguish from other STF sequences, with direct correlation receivers, while devices of the first type can detect the preamble, but cannot detect the STF sequence.

9. The apparatus of claim 1, wherein:
the preamble comprises a first set of one or more training fields located before a VHT-SIG field and a second set of training fields after the VHT-SIG field, followed by an additional SIG field.

10. The apparatus of claim 9, wherein the second set of one or more training fields has a repetition interval greater than 800 ns.

11. A method for wireless communications, comprising:
generating a packet having a preamble decodable by a first type of device having a first set of capabilities and a second type of device having a second set of capabilities; and
transmitting the packet, wherein at least one field of the preamble is transmitted in a manner that allows the second type of device to determine a cyclic prefix length used in transmitting the packet.

12. The method of claim 11, wherein the at least one field of the preamble comprises at least one of a L-STF, L-LTF, L-SIG, VHT-SIG, or VHT-STF field.

13. The method of claim 11, wherein the at least one field of the preamble is transmitted in a manner that allows the second type of device to determine, for a given channel bandwidth, a cyclic prefix length and a FFT size.

14. The method of claim 11, wherein:
the at least one field of the preamble is transmitted using at least one of BPSK or Q-BPSK modulation; and
wherein transmitting at least one field of the preamble in a manner that allows the second type of device to determine a cyclic prefix length used in transmitting the packet comprises transmitting a sequence, in an orthogonal dimension to the BPSK or Q-BPSK transmission, that identifies the cyclic prefix length and a FFT size used in transmitting the packet.

15. The method of claim 11, wherein:
the first type of device is compatible with a first version of a standard in which one or more bits in the at least one field of the preamble are reserved; and
one or more of the reserved bits are used to determine a cyclic prefix length used in transmitting the packet.

16. The method of claim 11, wherein the at least one field of the preamble comprises a VHT-SIG field.

17. The method of claim 11, wherein:
the at least one field of the preamble comprises a STF field; and
the STF field comprises a STF sequence that devices of the second type can distinguish from other STF sequences, with direct correlation receivers, while devices of the first type can detect the preamble, but cannot detect the STF sequence.

18. The method of claim 11, wherein:
the preamble comprises a first set of one or more training fields located before a VHT-SIG field and a second set of training fields after the VHT-SIG field, followed by an additional SIG field.

19. The method of claim 18, wherein the second set of one or more training fields has a repetition interval greater than 800 ns.

20. An access point for wireless communications, comprising:
at least one antenna;
a processing system configured to generate a packet having a preamble decodable by a first type of wireless station having a first set of capabilities and a second type of wireless station having a second set of capabilities; and
a transmitter configured to transmit the packet via the at least one antenna to at least one wireless station, wherein at least one field of the preamble is transmitted in a manner that allows the second type of wireless station to determine a cyclic prefix length used in transmitting the packet.
